(19) United States
(12) Patent Application Publication
(10) Pub. No.: US 2010/0138871 A1
(43) Pub. Date: Jun. 3, 2010

(54) BROADCAST CLIP SCHEDULER

(75) Inventors: Shemimon Manalikudy Anthru, Monmouth Junction, NJ (US); Jill McDonald Boyce, Manalapan, NJ (US); David Anthony Campana, Princeton, NJ (US); David Brian Anderson, Florence, NJ (US); Avinash Sridhar, Plainsboro, NJ (US)

Correspondence Address: Robert D. Shedd, Patent Operations;THOMSON Licensing LLC, P.O. Box 5312, Princeton, NJ, 08543-5312, US

(73) Assignee: Thomson Licensing

(21) Appl. No.: 12/452,973

(22) PCT Filed: Jun. 17, 2008
(86) PCT No.: PCT/US08/07538

§ 371 Date: Jan. 29, 2010

Related U.S. Application Data
(60) Provisional application No. 60/963,782, filed on Aug. 7, 2007.

(51) Int. Cl. H04N 5/445

(52) U.S. Cl. 725/54

(57) ABSTRACT

A scheduler schedules multimedia content files for transmission over a broadcast network. Multimedia content files can be any sort of audio/video clips like, sports video, music video, news clip, movie sound track etc. In particular, the scheduler determines a transmission order for content files and generates an electronic service guide having a static part and a dynamic part such that content scheduled in the dynamic part may have a different transmission order in different versions of the electronic service guide. Schedule timing information and meta data information is transmitted over a broadcast network along with the clips so that receivers can do selective reception of their preferred clips, saving battery power and storage.

### BACKGROUND OF THE INVENTION

The present invention generally relates to communications systems and, more particularly, to wireless systems, e.g., terrestrial broadcast, cellular, Wireless-Fidelity (Wi-Fi), satellite, etc.

Today, mobile devices are everywhere—from MP3 players to personal digital assistants to cellular telephones to mobile televisions (TVs). Unfortunately, a mobile device typically has limitations on computational resources and/or power. In this regard, an Internet Protocol (IP) Datacast over Digital Video Broadcasting-Handheld (DVB-H) system is an end-to-end broadcast system for delivery of any type of file and service using IP-based mechanisms that is optimized for such devices. For example, see ETSI EN 302 304 V1.1.1 (2004-11) “Digital Video Broadcasting (DVB); Transmission System for Handheld Terminals (DVB-H)”; ETSI EN 300 468 V1.7.1 (2006-05) “Digital Video Broadcasting (DVB); Specification for Service Information (SI) in DVB systems”; ETSI TS 102 472 V1.1.1 (2006-06) “Digital Video Broadcasting (DVB); IP Datacast over DVB-H: Content Delivery Protocols”; and ETSI TS 102 471 V1.1.1 (2006-04) “Digital Video Broadcasting (DVB); IP Datacast over DVB-H: Electronic Service Guide (ESG)”. An example of an IP Datacast over DVB-H system as known in the art is shown in FIG. 1. In FIG. 1, a head-end 10 (also referred to herein as a “server”) broadcasts, via antenna 35, a DVB-H signal 36 to one, or more, receiving devices (also referred to herein as “clients” or “receivers”) as represented by receiver 90. The DVB-H signal 36 conveys the IP Datacasts to the clients. Receiver 90 receives DVB-H signal 36, via an antenna (not shown), for recovery therefrom of the IP Datacasts. The system of FIG. 1 is representative of a unidirectional network.

The above-described IP Datacasts are used to provide content-based services by distributing files such as an electronic service guide (ESG) and content files. In the context of FIG. 1, a content-based service can be real-time content, e.g., a television (TV) program, or file-based content, e.g., short-form content, which is shorter than a typical TV program. The ESG provides the user with an ability to select content-based services and enable the receiver to recover the selected content. In this regard, an ESG typically includes descriptive data, or metadata, about the content (the “content” is also referred to herein as an event). This metadata is referred to herein as “content metadata”, which includes, e.g., the name of the TV program, a synopsis, actors, director, etc., as well as the scheduled time, date, duration and channel for broadcast. A user associated with receiver 90 can receive content that is referred to by the ESG by tuning receiver 90 to the appropriate channel identified by the ESG. It should be noted that in the case of real-time content, e.g., a TV broadcast, the ESG includes a Session Description Protocol (SDP) file (e.g., see M. Handley, V. Jacobson, April 1998—“RFC 2327—SDP: Session Description Protocol). The SDP file includes additional information that enables receiver 90 to tune into selected broadcast content.

With respect to file-based content, head-end 10 of FIG. 1 distributes files using the File Delivery over Unidirectional Transport (FLUTE) protocol (e.g., see T. Paila, M. Luby, V. Roca, R. Walsh, “RFC 3926—FLUTE—File Delivery over Unidirectional Transport,” October 2004). The FLUTE protocol is used to transmit files, or data, over unidirectional networks and provides for multicast file delivery. In this example, it is also assumed that head-end 10 uses the Asynchronous Layered Coding (ALC) protocol (e.g., see Luby, M., Gemmell, J., Vicisano, L., Rizzo, L., and J. Crowcroft, “Asynchronous Layered Coding (ALC) Protocol Instantiation”, RFC 3450, December 2002) as the basic transport for FLUTE. The ALC protocol is designed for delivery of arbitrary binary objects. It is especially suitable for massively scalable, unidirectional, multicast distribution.

Turning briefly to FIG. 2, the transmission of file-based content using FLUTE is illustrated in the context of head-end 10 broadcasting an ESG. Transmission of other file-based content is similar and not described herein. Head-end 10 comprises ESG generator 15, FLUTE sender 20, IP encapsulator 25 and DVB-H modulator 30. ESG generator 15 provides an ESG to FLUTE sender 20, which formats the ESG in accordance with FLUTE over ALC and provides the resulting ALC packets conveying the FLUTE files to IP encapsulator 25 for encapsulation within IP packets as known in the art. The resulting IP packets are provided to DVB-H modulator 30 for transmission to one, or more, receiving devices as illustrated in FIG. 1. A receiver tunes to a particular FLUTE channel (e.g., IP address and port number) to recover the ESG for use in the receiver.

As noted above, a receiver may have power limitations, e.g., battery life. In addition, a receiver in a broadcast network may only be receiving particular, or selected, file-based content at particular times. At other times, the receiver—while being fully powered up—is not processing any other content transmitted by the broadcast network. As such, it would be beneficial if the FLUTE sender (e.g., FLUTE sender 20 of head-end 10 of FIG. 2) and the FLUTE receiver (e.g., the FLUTE receiver portion (not shown) of receiver 90 of FIG. 1) were time synchronized such that the receiver could reduce power during those time intervals when the selected information is not being received so as to increase the battery life of the receiver. One approach for performing time synchronization is shown in FIG. 3. In particular, in FIG. 3, timing synchronization is performed between head-end 10 and receiver 90 via a Network Time Protocol (NTP) server 45. In this case, FLUTE sender 20 (of head-end 10) provides a Time and Date Table (TDT) (e.g., see the above-referenced ETSI EN 300 468 V1.7.1) that includes an NTP timestamp from NTP server 45. Head-end 10 broadcasts the TDT in DVB-H signal 36. Receiver 90 then uses just the received NTP time stamp to look for selected content at particular times. Alternatively, head-end 10 can provide the NTP time stamp to receiver 90 in Real-time Transport Control Protocol (RTCP) Sender Reports that are included in a Live Service broadcast (e.g., see Audio-Video Transport Working Group, H. Schulzrinne, GMD Fokus S. Casner, Precept Software, Inc., R. Frederick, Xerox Palo Alto Research Center, V. Jacobson., January 1996—“RFC 1889 RTP: A Transport Protocol for Real-Time Applications).

Unidirectional broadcast networks (e.g., as shown in FIG. 1) are an ideal choice for scalable broadcasting of multimedia or data contents. The broadcast networks are widely used especially for multimedia content transmission and streaming. But this kind of network lacks the ability to do point-to-point services for the receivers and also does not have any reverse channel for the receivers to inform the sender about their preferences.

### SUMMARY OF THE INVENTION

In order to make a Push-Video On Demand (VOD) kind of service that works over broadcast networks, the sender has to satisfy the maximum number of receivers in getting their preferred content. In addition, the content providers and operators will also have their own priorities for transmission. An “operator” (also referred to as a service provider) is an entity that defines a broadcast service and provisions the contents for the service; a “content provider” is an entity that creates the content for a particular service or set of services.

Therefore, and in accordance with the principles of the invention, a server determines a program guide having a static part and a dynamic part, wherein a transmission order of content represented in the static part is determined from a transmission order of the corresponding content in a previously determined program guide while a transmission order of content represented in the dynamic part can vary from the transmission order of the corresponding content in the previously determined program guide;

In an illustrative embodiment of the invention, the head-end includes a scheduler that determines a transmission order for content files and generates an electronic service guide having a static part and a dynamic part such that content scheduled in the dynamic part may have a different transmission order in different versions of the electronic service guide. Schedule timing information and meta data information is transmitted over a broadcast network along with the clips so that receivers can do selective reception of their preferred clips, saving battery power and storage.

In view of the above, and as will be apparent from reading the detailed description, other embodiments and features are also possible and fall within the principles of the invention.

### BRIEF DESCRIPTION OF THE DRAWINGS

FIGS. 1-3 shows a prior art Internet Protocol (IP) Datacast over Digital Video Broadcasting-Handheld (DVB-H) system;

FIGS. 4 and 5 illustrate file-based content transmission and an associated fragment of an ESG for the system of FIGS. 1-3;

FIG. 6 shows an illustrative embodiment of a system in accordance with the principles of the invention;

FIG. 7 shows an illustrative server in accordance with the principles of the invention;

FIG. 8 shows illustrative scheduling metadata in accordance with the principles of the invention;

FIG. 9 shows an illustrative flow chart for use in server 150 in accordance with the principles of the invention;

FIG. 10 shows an illustrative schedule in accordance with the principles of the invention;

FIGS. 11 and 12 show other illustrative flow charts for use in server 150 in accordance with the principles of the invention;

FIG. 13 show other illustrative schedules in accordance with the principles of the invention;

FIGS. 14 and 15 show illustrative embodiments of a receiver in accordance with the principles of the invention;

FIG. 16 shows an illustrative flow chart for use in a receiver in accordance with the principles of the invention; and

FIG. 17 shows another illustrative server in accordance with the principles of the invention.

### DETAILED DESCRIPTION

Other than the inventive concept, the elements shown in the figures are well known and will not be described in detail. For example, other than the inventive concept, familiarity with Discrete Multitone (DMT) transmission (also referred to as Orthogonal Frequency Division Multiplexing (OFDM) or Coded Orthogonal Frequency Division Multiplexing (COFDM)) is assumed and not described herein. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC), Chinese Digital Television System (GB) 20600-2006 and DVB-H is assumed. Likewise, other than the inventive concept, other transmission concepts such as eight-level vestigial sideband (8-VSB), Quadrature Amplitude Modulation (QAM), and receiver components such as a radiofrequency (RF) front-end (such as a low noise block, tuners, down converters, etc.), demodulators, correlators, leak integrators and squarers is assumed. Further, other than the inventive concept, familiarity with protocols such as the File Delivery over Unidirectional Transport (FLUTE) protocol, Asynchronous Layered Coding (ALC) protocol, Internet protocol (IP) and Internet Protocol Encapsulator (IPE), is assumed and not described herein. Similarly, other than the inventive concept, formatting and encoding methods (such as Moving Picture Expert Group (MPEG)-2 Systems Standard (ISO/IEC 13818-1)) for generating transport bit streams are well-known and not described herein. Familiarity with Pull-VOD and Push-VOD services are also assumed. In a Pull-VOD service the user requests a particular video clip and the server sends it to that particular user. In a Push-VOD service, the user's preferred video gets pushed into the receiver without the user actively requesting the video. It should also be noted that the inventive concept may be implemented using conventional programming techniques, which, as such, will not be described herein. Finally, like-numbers on the figures represent similar elements.

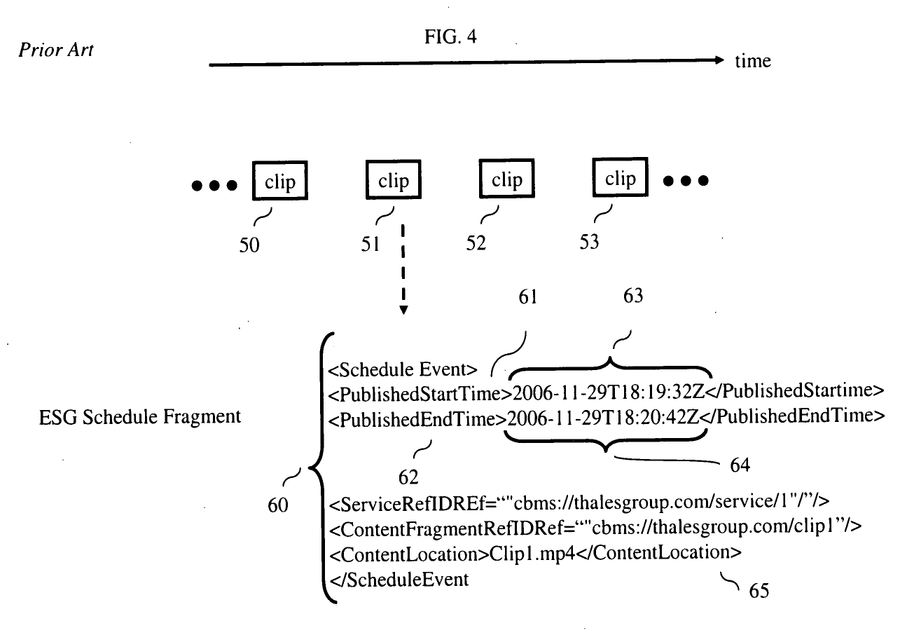

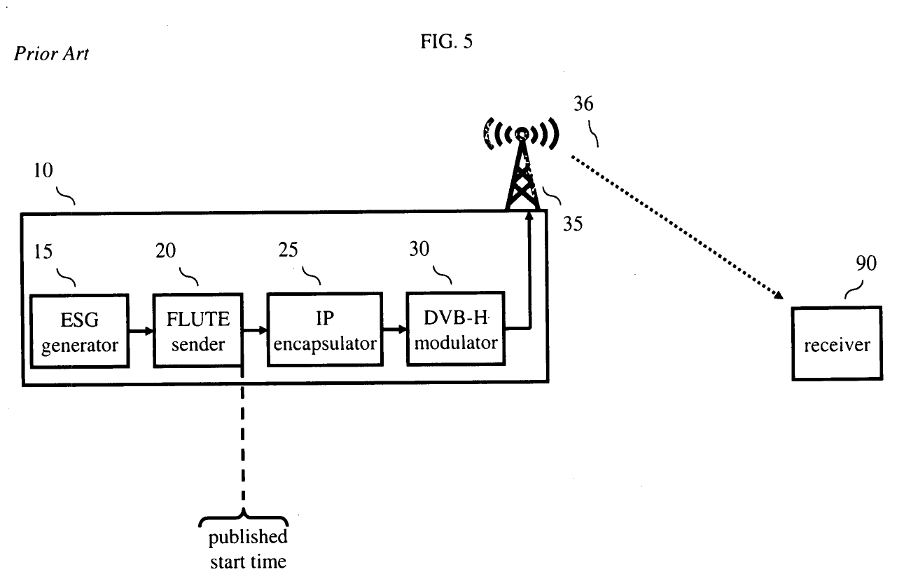

Before describing the inventive concept, FIG. 4 illustrates prior art file-based content transmission in DVB-H. In FIG. 4, file-based content transmission in DVB-H comprises a number of events (also referred to herein as clips) as represented by clips 50, 51, 52 and 53. Each clip may comprise a number of packets, but this is not relevant to the inventive concept. The ESG associates each clip with a start time, an end time and identifies the associated content file in the corresponding FLUTE session. This is illustrated in FIG. 4 for a fragment 60 of an ESG (ESG fragment 60) associated with clip 51. For simplicity other ESG data is not shown. As shown in FIG. 4, ESG fragment 60 includes a ContentLocation parameter 65, a PublishedStartTime parameter 61 as well as a PublishedEndTime parameter 62 associated with clip 51. In this example, the associated content file in the corresponding FLUTE session is “Clip1.mp4”. The actual values for the PublishedStartTime and PublishedEndTime, 63 and 64, respectively, are in Coordinated Universal Time (UTC) units. The value for the PublishedStartTime is the time that the FLUTE sender will actually start transmitting the files, i.e., the time at which the clip is handed off from the FLUTE sender to the next block in the system chain. This is further illustrated in FIG. 5 for a DVB-H system, i.e., the value for the PublishedStartTime is the time that FLUTE sender 20 hands off the clip to IP encapsulator 25.

As described earlier, in order to make a Push-VOD kind of service that works over broadcast networks, the sender has to satisfy the maximum number of receivers in getting their preferred content. In addition, the content providers and operators will also have their own priorities for transmission. An “operator” (also referred to as a service provider) is an entity that defines a broadcast service and provisions the contents for the service; a “content provider” is an entity that creates the content for a particular service or set of services.

In view of the above, we have observed a number of issues with regard to provisioning and scheduling content for transmission in a Push-VOD service. For example, the content database can change over a period of time and the operator preference can also change with the addition of new clips. As such, as new clips get added, priority based scheduling of clip transmission cannot just be performed since this can indefinitely block a less preferred clip from ever getting scheduled for broadcast.

In addition, the predictability of the schedule is another important factor. The schedule can change at any point of time due to the addition and removal of clips or even with a variation of priorities. However, in a unidirectional network environment the receiver terminal heavily depends on the schedule for timely reception of its preferred content. If the schedule is not predictable, the receiver has to stay on always and this unnecessarily wastes power. Moreover in a unidirectional network the receiver has no means to inform the sender about lost files. Hence, the predictability of the schedule is highly important for receiver operation.

Also, preference settings in a receiver can vary according to the personal interests of the user, location of the receiver, time of reception, etc. For example, in multimedia clip broadcast, it has been observed that viewers would naturally prefer to get new clips than getting a highly preferred clip over and over again. However, in a broadcast Push-VOD service there is no reverse channel that can immediately take into account preference settings. In this regard, any scheduling should address such issues when updating transmission schedules for multimedia clips.

In view of the above, a scheduler is described in accordance with the principles of the invention that enables a Push-VOD service to address the above-described issues. Therefore, and in accordance with the principles of the invention, a head-end determines a transmission order for content files as a function of a dynamic priority value, which is determined in accordance with at least a dissimilarity measure between the content files; and transmits the contents files in accordance with the determined transmission order.

In an illustrative embodiment of the invention, the content files can be any sort of audio/video clips like, sports video, music video, news clip, movie sound track etc., and “clip meta data” is associated with each clip. The head-end includes a scheduler that determines a transmission order for content files as a function of a dynamic priority value, which is determined in accordance with at least a dissimilarity measure between the content files; wherein the dissimilarity measure of the content files is further determined as a function of the clip meta data associated with each clip. Schedule timing information and meta data information is transmitted over a broadcast network along with the clips so that receivers can do selective reception of their preferred clips, saving battery power and storage.

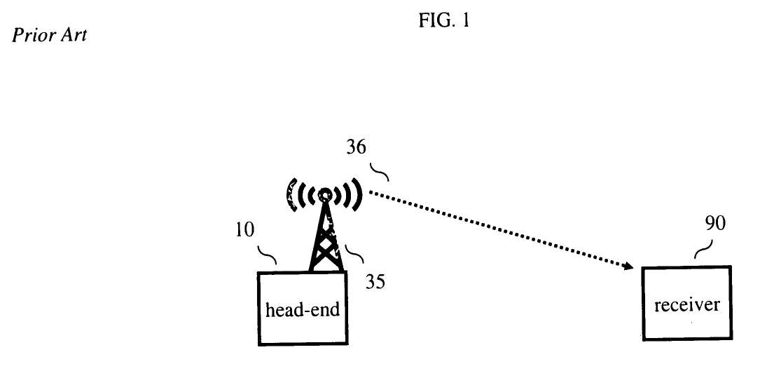

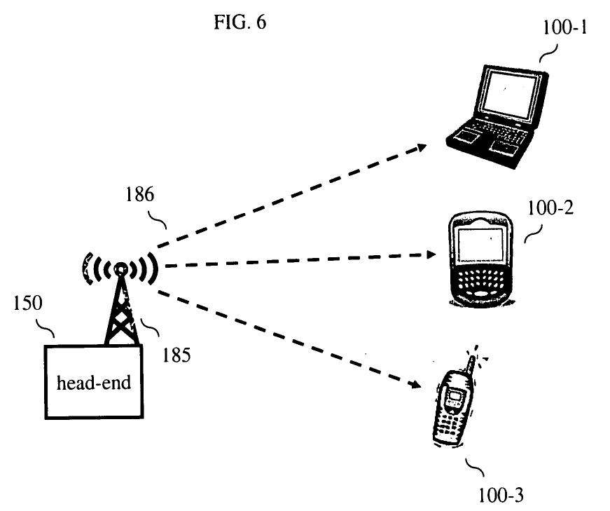

Turning now to FIG. 6, an illustrative system in accordance with the principles of the invention is shown. For the purposes of this example, and other than the inventive concept, it is assumed that the system shown in FIG. 6 is an IP Datacast over DVB-H system similar to that described in FIG. 1. In accordance with the principles of the invention, head-end 150 parses descriptive data associated with multimedia content files for determining a transmission order for the multimedia content files; and transmits the multimedia contents files in accordance with the determined transmission order, via antenna 185. In particular, head-end 150 broadcasts a DVB-H signal 186 for broadcasting IP Datacasts to one, or more, receiving devices (also referred to herein as “clients” or “receivers”) as represented by any one of laptop computer 100-1, personal digital assistant (PDA) 100-2 and cellular telephone 100-3, each of which are assumed to be configured to receive a DVB-H signal for recovery therefrom of the broadcast IP Datacasts for real-time content and file-based content. The system of FIG. 6 is representative of a unidirectional network. However, the inventive concept is not so limited.

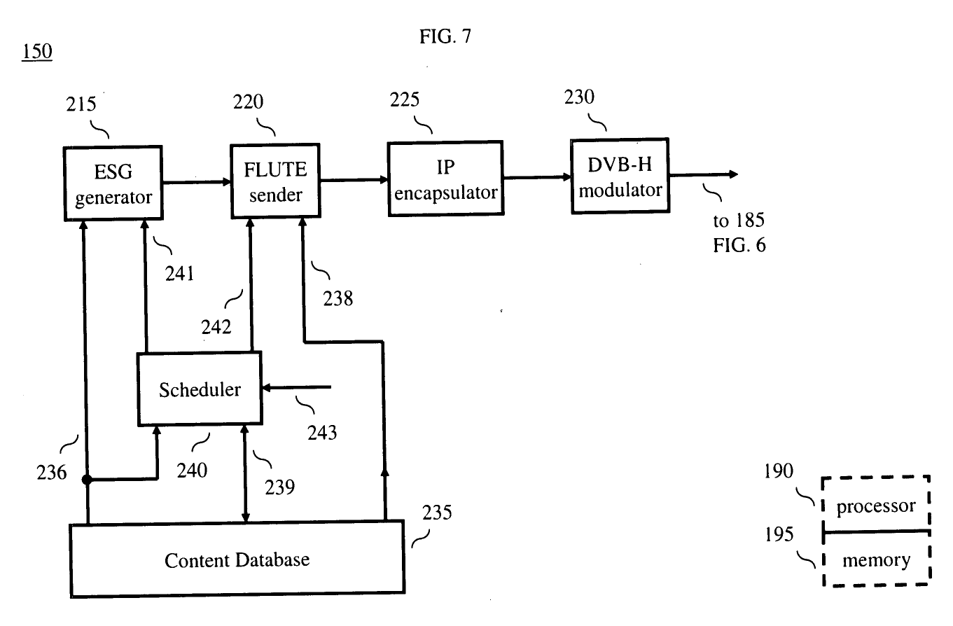

An illustrative embodiment of a head-end, or server, 150 in accordance with the principles of the invention is shown in FIG. 7. Other than the inventive concept, the elements shown in FIG. 7 are well-known and not described herein. Head-end 150 is a processor-based system and includes one, or more, processors and associated memory as represented by processor 190 and memory 195 shown in the form of dashed boxes in FIG. 7. In this context, computer programs, or software, are stored in memory 195 for execution by processor 190 and, e.g., implement the scheduler 240. Processor 190 is representative of one, or more, stored-program control processors and these do not have to be dedicated to the scheduling function, e.g., processor 190 may also control other functions of head-end 150. Memory 195 is representative of any storage device, e.g., random-access memory (RAM), read-only memory (ROM), etc.; may be internal and/or external to head-end 150; and is volatile and/or non-volatile as necessary.

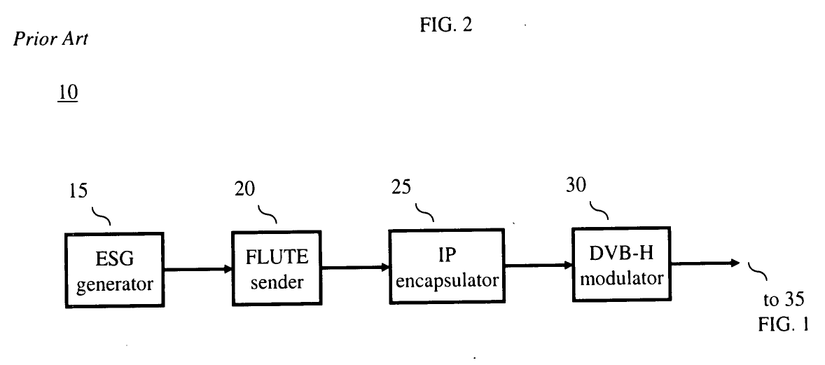

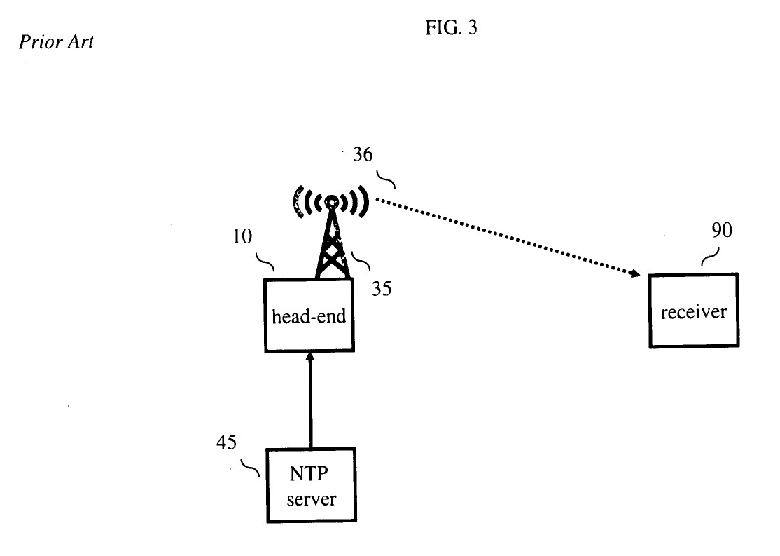

Head-end 150 comprises ESG generator 215, FLUTE sender 220, IP encapsulator 225, DVB-H modulator 230, content database 235 and scheduler 240. ESG generator 215, FLUTE sender 220, IP encapsulator 225 and DVB-H modulator 230 are similar to the corresponding components shown in FIG. 2 and will not be further described herein. Other than the inventive concept, described below, ESG generator 215 provides an ESG to FLUTE sender 220, which formats the ESG in accordance with FLUTE over ALC and provides the resulting ALC packets conveying the FLUTE files to IP encapsulator 225 for encapsulation within IP packets as known in the art. The resulting IP packets are provided to DVB-H modulator 230 for transmission to one, or more, receiving devices as illustrated in FIG. 6. A receiver (e.g., receiver 100-2 of FIG. 6) tunes to a particular FLUTE channel (e.g., IP address and port number) to recover the ESG for use in the receiver.

As shown in FIG. 7, head-end 150 also comprises content database 235 and scheduler 240. Content database 235 stores content, i.e., multimedia content files. These multimedia content files are any sort of audio/video clips like, sports video, music video, news clip, movie sound track, etc. Other than the inventive concept, these clips are provided to FLUTE sender 220, via signal 238, and transmitted as file-based content transmission in DVB-H as described above with respect to FIG. 4. Associated with each clip is content metadata. The content metadata for each clip is provided to ESG generator 215 and, in accordance with the principles of the invention, to scheduler 240, via signal 236. Scheduler 240 controls and monitors content database 235 via signal 239. As a result, scheduler 240 detects changes to content database 235, e.g., the addition/deletion or modification by changing content meta data of clips.

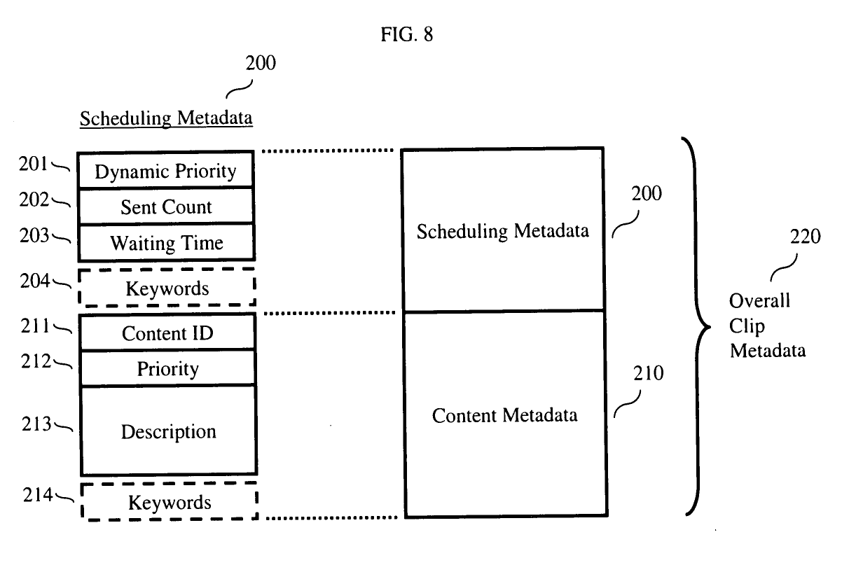

In accordance with the principles of the invention, scheduler 240 parses the content metadata associated with the clips stored in content database 235 for determining a transmission order for the multimedia content files. In this regard, scheduler 240 controls the transmission order, via control signal 242, to FLUTE sender 220. In addition, scheduler 240 provides additional scheduling information, via signal 241, to ESG generator 215 for use in forming the ESG transmitted to the receivers. This additional scheduling information is referred to herein as “scheduling metadata”. In particular, in addition to the content metadata associated with each clip, scheduler 240 adds scheduling metadata as shown in FIG. 8. Scheduling metadata 200 comprises a number of fields: a Dynamic Priority 201, a Sent Count 202, a Waiting Time 203 and, optionally, Keywords 204 (shown in dashed-line form). Thus, for each clip there is now scheduling metadata 200 in addition to content metadata 210. This is referred to herein as overall clip metadata 220 as shown in FIG. 8. Content metadata 210 is stored in content database 235. Content metadata 210 comprises a Content ID 211, a Priority 212, a Description 213 and, optionally, Keywords 214 (shown in dashed-line form). Illustratively, XML (eXtensible Markup Language) can be used to represent the meta data.

With regard to content metadata 210, Content ID 211 is a unique numerical identifier for identifying each clip in content database 235. The Priority 212 is a numerical value representing a priority level for the identified clip. Description 213 is, e.g., the name of the TV program, a synopsis, actors, director, etc., as well as the scheduled time, date, duration and channel for broadcast. Finally, the Keywords 214 is a list of alpha-numeric words representing one or more keywords briefly describing the content in the identified clip.

With regard to scheduling metadata 200, the Dynamic Priority 201 is a numerical value representing the actual priority level for broadcasting or transmitting the identified clip. The Sent Count 202 is a numerical value representing the number of times the identified clip as been broadcast, or transmitted. The Waiting Time 203 is a numerical value representing the number of seconds that have elapsed since the identified clip was last broadcast. Finally, the Keywords 204 is a list of alpha-numeric words representing one or more keywords briefly describing the content in the identified clip. As noted above, keywords can be located in either scheduling metadata 200 or content metadata 210. In the former, Keywords 204 is determined by scheduler 240 parsing description 213. In the latter, Keyword 214 is set by an operator as a part of the content metadata 210.

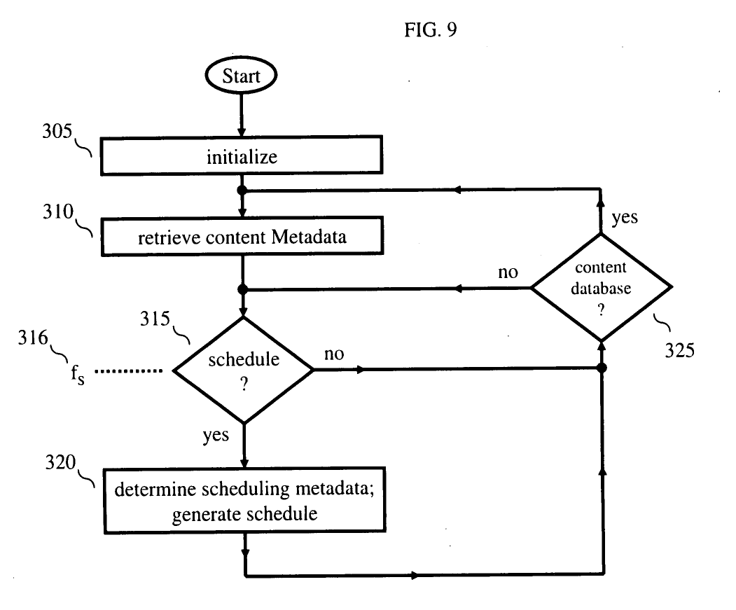

Attention now should be directed to the flow chart of FIG. 9, which shows an illustrative scheduling method in accordance with the principles of the invention. In step 305, scheduler 240 initializes and determines the scheduling frequency, f_{S}, 316 as well as the schedule static part (described below). The scheduling frequency, f_{S}, 316 is illustratively determined a priori, as is the schedule static part, e.g., these are values stored in memory 195 of FIG. 7. These values can also be set by the operator via signal 243 (e.g., via a keyboard/console (not shown). The scheduling frequency, f_{S}, 316 determines how frequently a schedule is generated. In step 310, scheduler 240 retrieves content metadata for clips stored in content database 235.

In step 315, scheduler 240 checks if its time to generate the schedule, which is determined by the scheduling frequency, f_{S}, 316. If its not time to generate a schedule, then scheduler 240 checks if content database 235 has been updated in step 325 (e.g., via signal 239 of FIG. 7). If content database 235 has not been updated, then scheduler 240 again checks if its time to generate a schedule in step 315. However, if content database 235 has been updated, then scheduler 240 retrieves the updated content in step 310. This updated content represents changed content, new content or content that has been deleted. In this regard, scheduler 240 performs the requisite processing in step 310 to create, update or delete the retrieved content metadata as necessary.

Once scheduler 240 determines in step 315 that it is time to generate a schedule, then execution proceeds to step 320, where scheduler 240 determines or updates values for scheduling metadata 200 for each identified clip and generates a schedule. First, if necessary, scheduler 240 parses description 213 to determine keywords for the Keywords 204 field of scheduling metadata 200. Alternatively, scheduler 240 uses Keywords 214 if present. Then, scheduler 240 determines a value representative of the actual priority for the identified clip (Content ID 211) and stores this value in Dynamic Priority 201 (described further below). Scheduler 240 also updates the value of Sent Count 202 to represent the number of times the identified clip has been sent; and updates the value of Waiting Time 203 to represent the number of seconds that have elapsed since the identified clip was last broadcast. Once the scheduling metadata for each identified clip has been determined, scheduler 240 generates the schedule for use by ESG generator 215 (via signal 241) and FLUTE sender 220 (via signal 242). Execution continues with step 325. It should also be noted that, for simplicity, other termination and/or error conditions are not shown in the flow charts described herein.

In order to avoid unnecessary implementation complexities both on the receiver side and sender side, the scheduler 240 is illustratively designed as a non-preemptive scheduler. This means that each video clip or any other content file does not get split into small chunks and transmission does not get spread over different time slots. In other words, once content transmission is started, the transmission does not get interrupted by scheduler 240 until the end in order to transmit another clip. This helps to minimize the time required for the completion of reception at the terminal. However, the inventive concept is not so limited and applies to a preemptive scheduler as well.

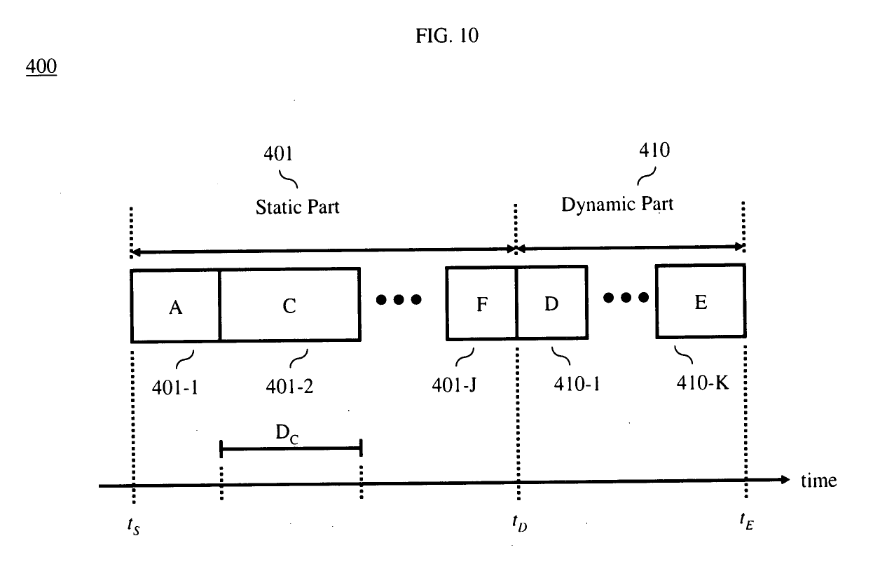

As noted above, scheduler 240 generates a schedule. In accordance with the principles of the invention, an illustrative schedule 400 is shown in FIG. 10. Schedule 400 comprises a static part 401 and a dynamic part 410. Static part 401 comprises J clips: A (401-1), C (401-2), . . . F (401-J), where J≧0, and dynamic part 410 comprises K clips: D (410-1) . . . E (410-K), where K≧0. The duration of the schedule is the end time minus the start time (i.e., t_{E}−t_{S}). As can be observed from FIG. 10, the static part 401 begins as start time, t_{S}, and ends at a time t_{D}. The latter time is the start of dynamic portion 410, which ends at the schedule end time, t_{E}. As can be observed from FIG. 10, each clip has an associated time duration. For example, clip C (401-2) has an associated duration of D_{C}. It should be noted that although FIG. 10 shows a static portion and a dynamic portion, the number of clips in either portion can be zero, e.g., t_{S} can equal t_{D}.

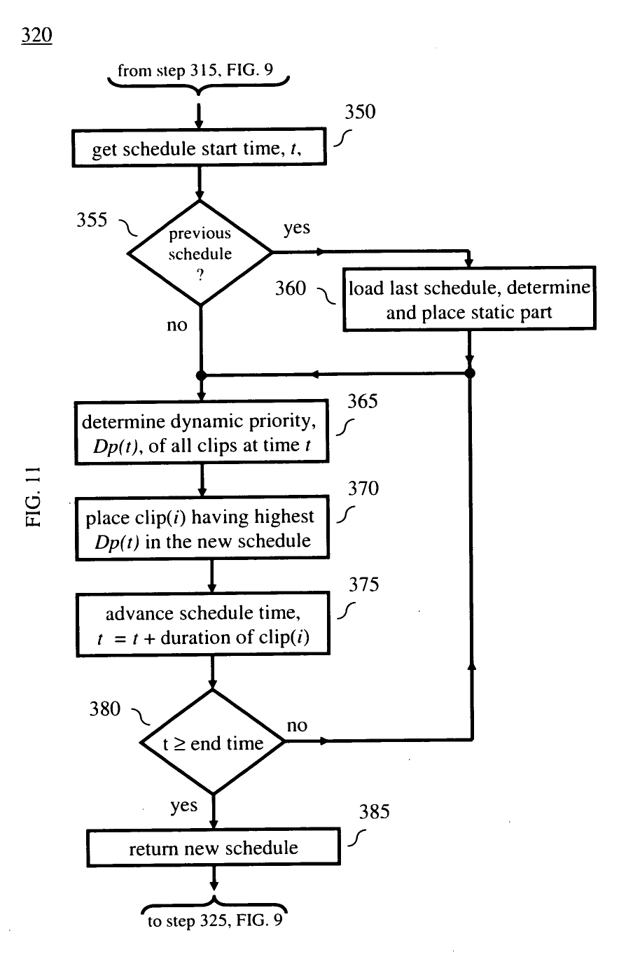

Referring now to FIG. 11, an illustrative flow chart for use in step 320 of FIG. 9 is shown. When it is time to generate a new schedule, a schedule time, t, is initialized, e.g., t_{S}=0, in step 350 of FIG. 11. In step 355, scheduler 240 checks if a previous schedule exists. If a previous schedule exists, then in step 360 scheduler 240 loads the previous schedule and sets t equal to the start time of the dynamic portion of the previous schedule, e.g., t=t_{D} for schedule 400 of FIG. 10. In any event, in step 365, scheduler 240 determines the dynamic priority (Dp(t)) of each clip or content retrieved for this scheduling session (described further below). In step 370, the clip(i) having the highest dynamic priority Dp(t) is placed in the new schedule starting at schedule time, t. This clip(i) has an associated duration of D. In step 375, schedule time t is advanced to t=t+Dᵢ. In step 380, the schedule time t, is checked against the schedule end time, t_{E}. If the end of the schedule has been reached, the scheduler 240 returns, or generates, the new schedule in step 385. However, if the end of the schedule has not been reached, then scheduler 240 recalculates the dynamic priority (Dp(t)) for the remaining clips in step 365 and again selects that clip with the highest dynamic priority (Dp(t)), etc. This process repeats until scheduler 240 fills the whole schedule. As shown in the flow chart, the start time “t” gets adjusted before doing dynamic priority calculation if a previous schedule is present in the system. In this case, events in the static part of the previous schedule are copied into the new schedule without change. This is done to make the schedule more predictable at the receiver (described below).

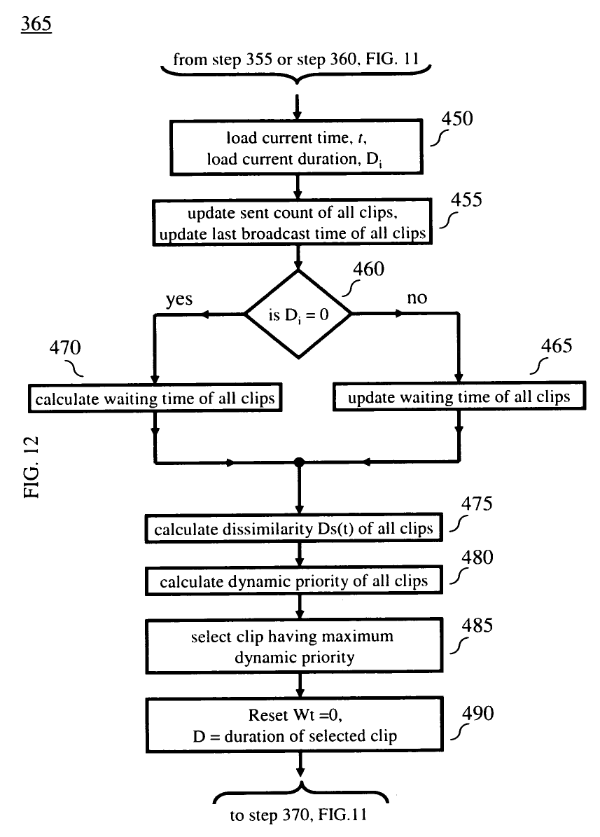

It can be seen from flow chart of FIG. 11 that the clip scheduled at a particular time instant, t, is determined by the dynamic priority of the clip at that instant. An illustrative embodiment of step 365 of FIG. 11 is shown in FIG. 12. In step 450, scheduler 240 loads the current schedule time, t, and the current duration, Dᵢ. The current duration, Dᵢ, is equal to zero, if no previous schedule existed and no clip has currently been scheduled in this scheduling session. If a previous schedule does exist, but no clip has currently been scheduled in this scheduling session, then Dᵢ is equal to the difference between the start of the dynamic portion, t_{D}, and the start of the static portion. Otherwise, Dᵢ is equal to the duration of the last clip scheduled. In step 455, scheduler 455 updates the sent count of all clips (e.g., sent count 202 of FIG. 8) and also updates the last broadcast time of all clips. In step 460, scheduler 240 checks the value of the current duration, Dᵢ. If the value of the current duration, Dᵢ, is equal to zero, then, in step 470, the waiting time, Wt, for each clip (also shown as waiting time 203 shown in FIG. 8) is calculated as:

Wt=last broadcast time of clip(i)−t, (1)

which is simply the difference between the current time and the last broadcast time for that clip. However, if the value of the current duration, Dᵢ, is not equal to zero, then, in step 465, this duration is added to the waiting time, Wt, for each clip (also shown as waiting time 203 shown in FIG. 8) and is calculated as:

Wt=Wt+Dᵢ, (2)

where Di represents the duration of the previously scheduled clip (or the time duration of the static part of the schedule).

In step 475, scheduler 240 determines the dissimilarity of clips not yet scheduled for transmission. In this regard, it should be noted that in realizing a Push-VOD kind of application over broadcast there is a lack of a feedback channel. There is no reverse channel for the end users to inform their preference to the sender. In a Push-VOD kind of application, there is typically a wide variety of users (receivers) whose priorities will be different from each other. A scheduler that doesn't take into account this particular issue is not ideal for a Push-VOD kind of application. For example, an enthusiast soccer fan is never going to like the Push-VOD application if he has to wait till the end of the next 10 clips of news and music video transmission in order to get the soccer world cup highlight.

In order to take into account the possibility of a wide variety of viewer preference, and in accordance with the principles of the invention, scheduler 240 gives a weighting for the dissimilarity of each of the clips available for scheduling compared to the previously scheduled clip in step 475 of FIG. 12. For example, the most dissimilar clip at time, t, will have a larger dissimilar weighting value than other clips. This dissimilarity weighting value is then subsequently used in determined the dynamic priority of a clip, with the result (not taking into account other factors, described below) that dissimilar clips are scheduled to be transmitted adjacent to each other, instead of queuing up similar clips for transmission back to back. In order to find out how similar an unscheduled clip is compared to a scheduled clip, the scheduler illustratively makes use of the keyword data (keywords 204 of FIG. 8) associated with each clip. As noted above, the content provider can provide this keyword data and/or the operator can also specify additional keywords to better categorize the content. Alternatively, as also noted above, scheduler 240 can parse description 213, of FIG. 8, to form keywords by itself for storage in keywords 204. The entire list of keywords in keywords 204 or keywords 214 for a particular clip is compared against respective keywords of other clips to get a measure of similarity. There are several ways to calculate the rate of correlation between two sets of keywords. For example by taking a dot product of two vectors, one can find the correlation between them.

Illustratively, in step 475, scheduler performs the following similarity measure between two clips, e.g., an unscheduled clip—denoted as clip X—and the last scheduled clip—denoted as clip Y.

$$S ( x , y ) = \frac{Ns}{\sqrt{N ( x )} * \sqrt{N ( y )}} , \qquad ( 3 )$$

where S(x,y) is the similarity measure between clip X and clip Y; Ns is the number of similar keywords in both clip X and clip Y; N(x) is the total number of keywords in clip X and N(y) is the total number of keywords in clip Y. In equation (3), the value of S(x,y) can vary between 0 and 1. A value of 1 represents totally similar clips and a value of 0 represents totally dissimilar clips. Hence, the dissimilarity measure becomes

Ds(x,y)=1−S(x,y). (4)

This dissimilarity measure, Ds(x,y), of each unscheduled clip is then used by scheduler 240 in determining the dynamic priority for a clip. In this process the operator/content provider specified keywords are weighted more than the keywords generated by the scheduler by parsing synopsis/summary fields.

It should be noted that the dissimilarity measure can not only be done to identify the most dissimilar clip when compared to the previous one, but can also be extended to find out the most dissimilar clip when compared to the previous history of transmission. This is accomplished by making the dissimilarity measure a moving average of past dissimilarities. As such, in addition to equations (3) and (4), scheduler 240 may also further refine the dissimilarity measure. In particular, assume clip X having duration Δt is scheduled at a time “t−Δt”. Then Ds of each clip at time “t” can also be calculated as:

Ds(t)=(1−α)*Ds(x,i)+α*Ds(t−Δt), (5)

where Ds(x,i) is the dissimilarity of clip (i) against clip X (from equations (3) and (4)), Ds(t−Δt) is the dissimilarity value of clip (i) taken at time t−Δt, i.e., in a previous scheduling interval; and α is a constant whose value can range between 0 to 1. The value of α is chosen in such a way that more weighting is given to dissimilarity against the most recently scheduled clip than to the previous history.

After determining dissimilarity values for each unscheduled clip, scheduler 240 determines the dynamic priority in step 480 for all unscheduled clips. Illustratively, the dynamic priority of each clip at time “t” is given by:

Dp(t)=KpP+KdDs(t)+KwWt−KsSc, (6)

where Dp(t) is the dynamic priority of the clip at time t; P is the operator/content provider given priority of the clip (e.g., priority 212 of FIG. 8); Ds(t) is above-described dissimilarity measure of the clip at time t, (alternatively, Ds(x,y) can be used instead of Ds(t)), Wt is the waiting time of the clip at time t; Sc is the sent count of the clip, and Kp, Kd, Kw and Ks are constants that determine the relative weighting of operator priority, dissimilarity, aging and sent count, respectively. While these constants can be set a priori, these constants can also be tuned manually to get an optimum schedule or can be tuned in the scheduler by making use of optional aggregate feedback from viewers. The aggregate feed back is a collection of offline feed backs from viewers taken at different instances. It can be realized either through web portals or SMS (short message service) based gateways or other similar communication channels.

It should be noted that although dynamic priority was described in the context of equation (6), any one, two or three of the variables P, Ds(t), Wt and Sc can be used for determining dynamic priority. Indeed, additional parameters can also be defined besides these four for determining dynamic priority in accordance with the principles of the invention.

As noted above, illustratively, the sent count, Sc, is used in order to take into account in the scheduling process the number of times a clip has been transmitted. For example, in a video clip broadcast system, the viewers will always look for new clips. Typically, viewers will prefer a new clip over old ones and this is some times the case even if the old clips were highly rated by the operator or content provider. Hence the scheduler should take into account the number of times a clip has been transmitted and schedule the clip accordingly. The scheduler solves this problem by using Sc to count the number of times that particular clip has been sent. All new clips will have their sent count, Sc, value as zero. In determining the dynamic priority of a clip, the scheduler will reduce the priority in direct proportion to the sent count. In other words, the lower the sent count, the higher the rise in dynamic priority.

In this regard, since the scheduler gives preference to high priority content and special consideration towards newly added clips over old clips, there is a possibility that frequent addition of new clips may keep the low priority clips in the database indefinitely without ever getting sent. In order to compensate for this, the scheduler accounts for the aging of clips, via the parameter Wt in equation (6). As such, the dynamic priority of a clip increases as the waiting time increases.

It can also be observed from equation (6) that a raise in operator/content provider priority, P, of a clip leads to a direct raise in dynamic priority. Hence operator/content provider preferred clips will likely get scheduled early.

In step 485, scheduler 240 selects the clip having the highest, or maximum, dynamic priority, Dp(t) at time, t, for transmission and places this clip in the schedule. It should be noted that if a number of clips have equal dynamic priority, scheduler 240 can select one of the clips or perform a round robin schedule among equal dynamic priority clips. For example, if all dynamic priority measures of a set of clips results in the same value, the scheduler simply iterates through the set to create the schedule and thus makes sure that all of them get sent.

In step 490, the selected clip has its waiting time set to zero (e.g., waiting time 203 of FIG. 8) and Di is set equal to the duration of the selected clip so that on the next iteration of the scheduling process, this value of Di is used in step 450 (described above).

As noted above, predictability of the schedule is important. In a unidirectional broadcast environment, a receiver heavily depends on the schedule and meta data information it gets to do a selective reception of content. So it is very important that the receiver should receive the schedule in advance. Moreover if any schedule change happens on the server due to addition of new content or any other reason, the latest schedule needs to be sent to all receivers. The scheduler does this by sending a periodic schedule update, e.g., every T=1/f_{S} seconds, where f_{S}, is the earlier mentioned scheduling frequency. The periodic schedule update comprises, e.g., newly scheduled events and other meta data associated with the scheduled contents. Using this information the receiver can decide whether it needs to receive the content and when to tune in to get the content. Thus the terminals can save both power and storage space.

However, in practical systems, the frequency of the schedule update and instantaneous reception of the schedule update on the terminal is limited. In other words, once a schedule change happens on the server, it will take some time for the receivers to know about it. Let's consider this delay as the minimum schedule update interval on the terminal. In order to account for this minimum schedule update interval and the unpredictability due to this, and in accordance with the principles of the invention, the scheduler introduces another concept—splitting the schedule into static and dynamic parts as illustrated in FIG. 10.

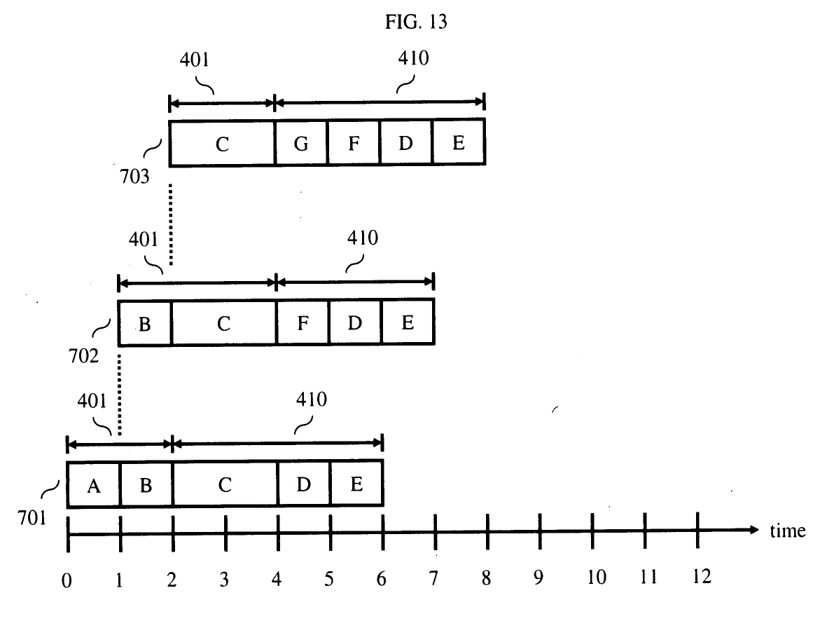

This is further illustrated in FIG. 13. This figure illustrates the formation of three ESGs, 701, 702 and 703 by scheduler 240 over consecutive intervals of time. For simplicity it is assumed an ESG is formed every minute and that there was no previous schedule. The first ESG, formed at minute 0, by scheduler 240 is ESG 701. In forming ESG 701, scheduler 240 determines that clips A, B, C, D and E are available for transmission and schedules them for transmission as shown in FIG. 13 in accordance with the above-described scheduling process of FIGS. 9, 11 and 12. As can be observed from FIG. 13, in ESG 701, clips A, B, D and E each have a duration of one minute, while clip C has a duration of two minutes. In addition, it is assumed that static part 401 has been defined a priori as having a duration of two minutes, with the remaining part of ESG 401 being designated as the dynamic part 410 of the ESG.

On the next scheduling interval, scheduler 240 determines that clips B, C, D, E and F are available for transmission (clip A having been sent). In addition, scheduler 240 determines that a prior schedule (ESG 701) existed and determines the static part 401. As noted earlier, scheduler 240 is illustratively designed as a non-preemptive scheduler. This means that each video clip or any other content file does not get split into small chunks and transmission does not get spread over different time slots. Thus, although static part 401 is defined has having a duration of two minutes (which would fall in the middle of clip C), static part 401 is temporarily extended to include the entire clip C. In other words, the static part has minimum time duration of two minutes. As a result, clips B and C are scheduled for transmission as previously determined in ESG 701. However, as can be observed from FIG. 13, in re-calculating the dynamic priorities of the transmission of clips D, E and F, in dynamic part 410, clip F is now scheduled for transmission ahead of clips D and E. Thus, e.g., clip D now has a different transmission order, or priority, in ESG 702 than clip D had in ESG 701.

Finally, on the next scheduling interval, scheduler 240 determines that clips C, D, E, F and G are available for transmission (clip B having been sent). In addition, scheduler 240 determines that a prior schedule (ESG 702) existed and determines the static part 401. However, now the static part 401 is set back to two minutes, since the static part 401 only includes clip C. Thus, clip C is scheduled for transmission as previously determined in ESG 702. However, as can be observed from FIG. 13, in re-calculating the dynamic priorities of the transmission of clips D, E, F and G, in dynamic part 410, clip G is now scheduled for transmission ahead of clips F, D and E. Thus, e.g., clip F now has a different transmission order, or priority, ESG 703 than clip F had in ESG 702.

In view of the above, the schedule produced by the scheduler at any point of time will have two parts. The static portion of the current schedule will have events that were present in the previous schedule in the corresponding time periods. The static portion of the schedule will also move forward on the time line as the schedule moves. In other words, if there is a static duration of 30 seconds, then the schedule made at time instant t will have a static portion ranging from time t to t+30 and the schedule made at t+1 second will have a static portion ranging from t+1 to t+31.

Whenever a reschedule happens, the new reschedule changes go to the dynamic part of the schedule, which starts from t+static duration, where t is the time instant of rescheduling. The static part of the new schedule is made by taking events corresponding to the time period t to t+static duration from the previous schedule. Even though a fixed duration can be configured for the static part (e.g., 30 seconds) the exact static part may change according to the duration of clips in the static part as illustrated above with respect to ESGs 701, 702 and 703 of FIG. 13.

The static duration of the schedule can be tuned over a period of time. Ideally the static duration equals the minimum schedule update interval required by the terminal. The rescheduling interval can also get tuned if required, to accommodate any overhead in processing and transmission of a new schedule. Thus any reschedule changes will get sent to the terminals, meanwhile the terminal can depend on the static part which is unchanged.

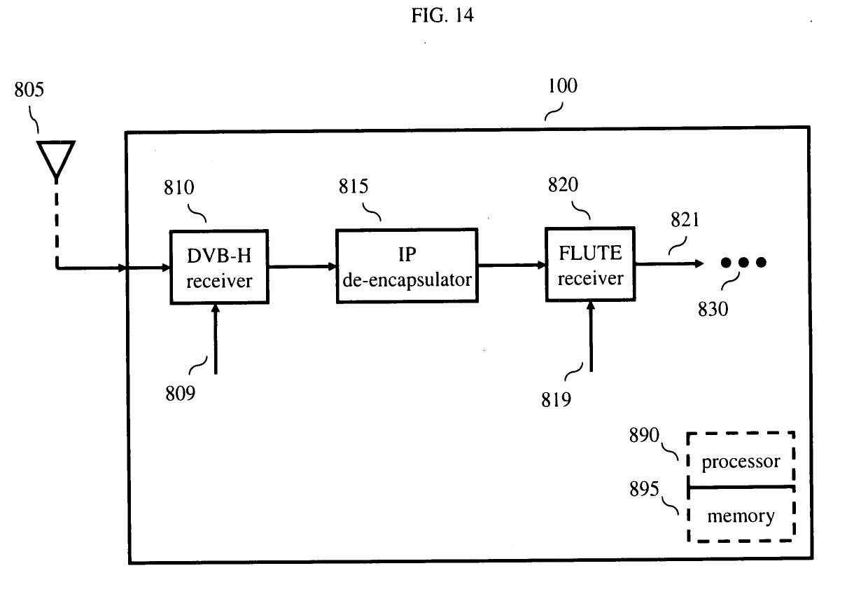

Referring now to FIG. 14, an illustrative embodiment of a receiver 100 in accordance with the principles of the invention is shown. Only that portion of receiver 100 relevant to the inventive concept is shown. Receiver 100 is representative of any processor-based platform, e.g., a PC, a personal digital assistant (PDA), a cellular telephone, a mobile digital television (DTV), etc. In this regard, receiver 100 includes one, or more, processors and associated memory as represented by processor 890 and memory 895 shown in the form of dashed boxes in FIG. 14. In this context, computer programs, or software, are stored in memory 895 for execution by processor 890. The latter is representative of one, or more, stored-program control processors and these do not have to be dedicated to the receiver function, e.g., processor 890 may also control other functions of receiver 100. Memory 895 is representative of any storage device, e.g., random-access memory (RAM), read-only memory (ROM), etc.; may be internal and/or external to receiver 100; and is volatile and/or non-volatile as necessary. Receiver 100 comprises DVB-H receiver 810, IP de-encapsulator 815 and FLUTE receiver 820. Any or all of these components may be implemented in software as represented by processor 890 and memory 895. DVB-H receiver 810 receives DVB-H signal 186 (of FIG. 6) via antenna 805 and provides a demodulated signal to IP de-encapsulator 815. The latter provides ALC packets to FLUTE receiver 820, which recovers content as represented by signal 821. This content may be further processed by receiver 100 as known in the art (as represented by ellipses 830). As described above, and in accordance with the principles of the invention, processor 890 recovers an ESG having a static part and a dynamic part for use in identifying selected clips (content). In this example, FLUTE receiver 820 and DVB-H receiver 810 are powered on, and off, by processor 890 as represented by control signals 809 and 819 such that at least for some of the unselected content receiver 100 operates at reduced power. As such, processor 890 adapts to at least the dynamic part of the ESG for scheduling reception of selected content represented in the received program guide.

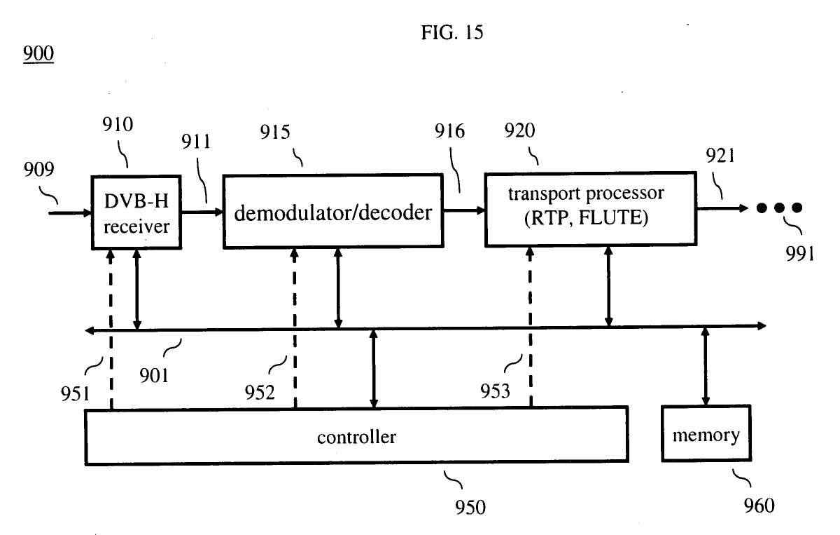

Another illustrative embodiment of a receiver 900 in accordance with the principles of the invention is shown in FIG. 15. Only that portion of receiver 900 relevant to the inventive concept is shown. Receiver 900 includes DVB-H receiver 910, demodulator/decoder 915, transport processor 920, controller 950 and memory 960. It should be noted that other components of a receiver, such as an analog-to-digital converter, front-end filter, etc., are not shown for simplicity. Both transport processor 920 and controller 950 are each representative of one or more microprocessors and/or digital signal processors (DSPs) and may include memory for executing programs and storing data. In this regard, memory 960 is representative of memory in receiver 900 and includes, e.g., any memory of transport processor 920 and/or controller 950. An illustrative bidirectional data and control bus 901 couples various ones of the elements of receiver 900 together as shown. Bus 901 is merely representative, e.g., individual signals (in a parallel and/or serial form) may be used, etc. for conveying data and control signaling between the elements of receiver 900. DVB-H receiver 910 receives a DVB-H signal 909 and provides a down-converted DVB-H signal 911 to demodulator/decoder 915. The latter performs demodulation and decoding of signal 911 and provides a decoded signal 916 to transport processor 920. Transport processor 920 is a packet processor and implements both a real-time protocol and FLUTE/ALC protocol stack to recover either real-time content or file-based content in accordance with DVB-H. Transport processor 920 provides content as represented by content signal 921 to appropriate subsequent circuitry (as represented by ellipses 991). Controller 950 controls transport processor 920, via bus 901, in accordance with the above-described flow charts to recover ESG information as represented by the ESGs of FIG. 13 for storage in memory 960. Controller 960 performs power management of transport processor 920, DVB-H receiver 910 and demodulator/decoder 915 in accordance with the principles of the invention via controls signals 951, 952 and 953 (via bus 901) in response to the static and dynamic part of received ESGs for selected clips (content). As such, controller 960 adapts to at least the dynamic part of the ESG for scheduling reception of selected content represented in the received program guide.

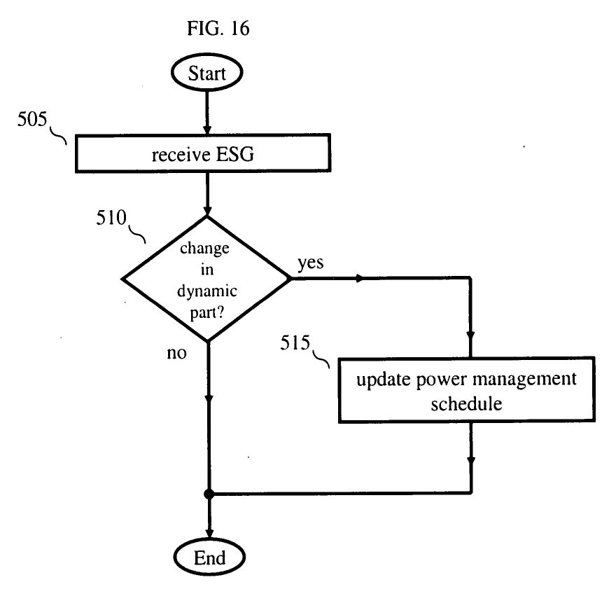

An illustrative flow chart for use in either receiver 100 or receiver 900 is shown in FIG. 16. In step 505, the receiver receives an ESG having a static part and a dynamic part, wherein a transmission order of content represented in the static part is determined from a transmission order of the corresponding content in a previously received program guide while a transmission order of content represented in the dynamic part can vary from the transmission order of the corresponding content in the previously received program guide. For example, the receiver receives ESG 702 of FIG. 13. In ESG 702, the transmission order of content represented in static part 401 is determined from ESG 701, while the transmission order of content represented in dynamic part 410 varies from the transmission order of the corresponding content in the previously received program guide as represented by ESG 701. For example, in ESG 701 (the previously received program guide), clips D and E were scheduled for transmission at 4 minutes and 5 minutes, respectively. However, in ESG 702 it can be observed that the transmission order has changed as clips D and E are now scheduled for transmission at 5 and 6 minutes respectively. Returning to FIG. 16, in step 510, the receiver determines if the dynamic part of the ESG has changed from a previously received ESG, e.g., by a comparison with a previously received ESG or by the use of version numbers in the ESG (not shown). If the dynamic part of the ESG has changed, the receiver updates any power management schedule in step 515 as necessary. For example, if clip D is selected content in the receiver, then, upon reception of ESG 701, the receiver would schedule reception at t=4 mins. However, after reception of ESG 702, the receiver detects the change in the dynamic part of the program guide and now schedules reception for the selected content, as represented by clip D at t=5 mins. Thus the receiver adapts to changes in at least the dynamic part of the received program guide for scheduling reception of selected content represented in the received program guide.

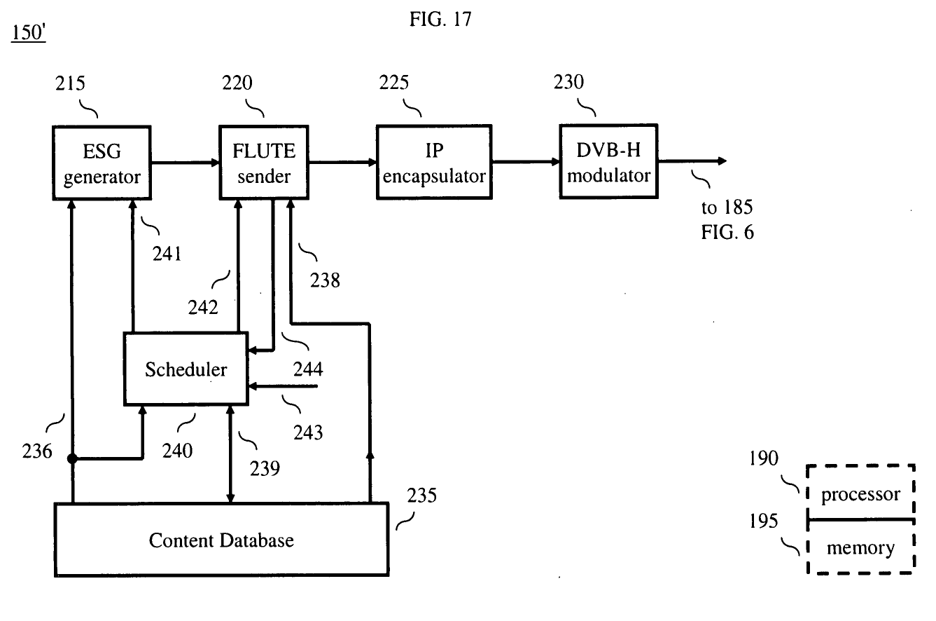

It should also be noted that in an opportunistic bandwidth environment (e.g., variable bit rate (VBR)) the output channel bandwidth is not constant. This affects all the timing calculations done by the scheduler. In order to account for this, the scheduler can be equipped with a bandwidth feedback interface. As such, scheduler 240 monitors the output bandwidth for calculating the transmission duration of each clip (duration=size of the clip/bandwidth) which will determine the time at which the scheduler can schedule the next clip. This is illustrated in server 150′ of FIG. 17, which is similar to server 150 of FIG. 7 except for feedback communication path 244 from FLUTE sender 220 to scheduler 240. As a result, scheduler 240 can constantly monitor the bandwidth variation and statistically predict the variation since FLUTE sender 220 notifies scheduler 240 upon the completion of transmission via feedback communication path 244. Hence, in the long run, the timing estimation the scheduler produces will have more accuracy. In addition, the scheduler can update the status of each content transmission. This helps to minimize the error in sent count calculation in a VBR environment.

As described above, the inventive concept addresses a number of problems in scheduling multimedia content files for transmission over a broadcast network. For example, the inventive concept enables the content database to change over a period of time, with, e.g., the addition and/or deletion of new clips. In addition, the operator preference associated with individual clips can also change over time. Further, the scheduler is applicable to either a CBR (Constant Bit Rate) output channel or a VBR (variable bit rate) output channel.

It should be noted that although the inventive concept was described in the context of a DVB-H system, the inventive concept is not so limited. In addition, although the inventive concept was described in the context of a particular number of elements in the scheduling metadata, the inventive concept is not so limited and additional, or less, fields may comprise the scheduling metadata. Also, although the scheduler was shown as a part of the server or head-end the invention is not so limited and the scheduler may be separate from the server for providing the scheduling information to an ESG and/or FLUE sender.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements (e.g., of FIG. 7) may be implemented in a stored-program-controlled processor, e.g., a digital signal processor, which executes associated software, e.g., corresponding to one, or more, steps of, e.g., FIGS. 9, 11 and 12. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention.

1. A method comprising:
determining a program guide having a static part and a dynamic part, wherein a transmission order of content represented in the static part is determined from a transmission order of the corresponding content in a previously determined program guide while a transmission order of content represented in the dynamic part can vary from the transmission order of the corresponding content in the previously determined program guide; and
transmitting the program guide.

2. The method of claim 1, wherein content is an audio clip or a video clip.

3. The method of claim 1, wherein the program guide is an electronic service guide.

4. The method of claim 1, wherein the static part has at least a minimum time duration.

5. Apparatus comprising:
a processor for determining a program guide having a static part and a dynamic part, wherein a transmission order of content represented in the static part is determined from a transmission order of the corresponding content in a previously determined program guide while a transmission order of content represented in the dynamic part can vary from the transmission order of the corresponding content in the previously determined program guide; and
a modulator for transmitting the program guide.

6. The apparatus of claim 5, wherein content is an audio clip or a video clip.

7. The apparatus of claim 5, wherein the program guide is an electronic service guide.

8. The apparatus of claim 5, wherein the static part has at least a minimum time duration.

9. Apparatus comprising:
a demodulator for use in recovering a signal representing a received program guide, the received program guide having a static part and a dynamic part, wherein a transmission order of content represented in the static part is determined from a transmission order of the corresponding content in a previously received program guide while a transmission order of content represented in the dynamic part can vary from the transmission order of the corresponding content in the previously received program guide; and
a processor for adapting to changes in at least the dynamic part of the received program guide for scheduling reception of selected content represented in the received program guide.

10. The apparatus of claim 9, wherein content is an audio clip or a video clip.

11. The apparatus of claim 9, wherein the program guide is an electronic service guide.

12. The apparatus of claim 9, wherein the static part has at least a minimum time duration.

13. A method comprising:
receiving a program guide, the received program guide having a static part and a dynamic part, wherein a transmission order of content represented in the static part is determined from a transmission order of the corresponding content in a previously received program guide while a transmission order of content represented in the dynamic part can vary from the transmission order of the corresponding content in the previously received program guide; and
adapting to changes in at least the dynamic part of the received program guide for scheduling reception of selected content represented in the received program guide.

14. The method of claim 13, wherein content is an audio clip or a video clip.

15. The method of claim 13, wherein the program guide is an electronic service guide.

16. The method of claim 13, wherein the static part has at least a minimum time duration.
